(19) United States
(12) Patent Application Publication
(10) Pub. No.: US 2002/0169792 A1
(43) Pub. Date: Nov. 14, 2002

(54) Method and system for archiving data within a predetermined time interval

(76) Inventors: Pierre Perinet, Fort Collins, CO (US); Eric Peterson, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/853,737

(22) Filed: May 10, 2001

(51) Int. Cl. G06F 12/00; G06F 17/30

(52) U.S. Cl. 707/204

(57) ABSTRACT

A method for archiving data using an archiver connected to a data collector having a list of available data sets of an Internet Usage Manager within a predetermined time interval, which includes the steps of obtaining a list of available data sets from the data collector, reading data for a data set from the list, associating read data to the data set, converting all the read data to a predefined archive format once data from each available data set in the list is read, saving the converted data to a file, and waiting for a predetermined time to repeat the foregoing steps.

The present invention generally relates to an improved method and system for archiving data. More specifically, it relates to an improved method and system for archiving data using an archiver connected to a data collector having a list of available data sets of an Internet Usage Manager within a predetermined time interval.

### BACKGROUND OF THE INVENTIVE ART

Because Internet servers can provide valuable information about their users, currently many software applications are designed to collect such usage data. The data includes important information relating to items, such as usage measure, geographical information, and user service requests. For example, the data can provide valuable information for a business manager in trying to understand the usage behavior of users, identify needs for new services, managing the pricing of subscription plans, and determining profit margin. All this information can provide managers with valuable marketing tools.

Software applications for collecting usage data are generally known as Internet Usage Managers (“IUM”). The present invention is designed specifically for an IUM disclosed in a commonly owned U.S. patent application filed on Apr. 12, 2000 entitled “Internet Usage Analysis System And Method” bearing Ser. No. ______ by Lee Rhodes, assigned to HP company. This patent application is specifically incorporated by reference herein.

An IUM typically includes a data collector for saving any user data relating to the server. The data collector is set up to collect data continuously. As a result, the usage data is not divided into various time intervals, which could be extremely valuable information relating to the users. For example, managers can track the behavior and traffic of the server in a particular month, week or day. However, since the data collector collects information continuously, this type of desired information is difficult to achieve using the data collector of the IUM. As a result, there is need for an improved IUM that collects data within a predetermined time interval selected by users. More specifically, an archiver connected to the IUM that can automatically archive data collected by the data collector according to a predetermined time interval is needed.

### BRIEF SUMMARY OF THE INVENTION

The present invention is directed to an improved method and system for archiving data. More specifically, it relates to an improved method and system for archiving data using an archiver connected to a data collector having a list of available data sets of an Internet Usage Manager within a predetermined time interval.

The present invention provides a method that includes the steps of obtaining a list of available data sets from the data collector, reading data for a data set from the list, associating read data to the data set, converting all the read data to a predefined archive format once data from each available data set in the list is read, saving the converted data to a file and waiting for a predetermined time to repeat the foregoing steps.

The present invention also provides a system that includes an Internet Usage Manager system for managing server usage data, a data collector of the IUM for collecting the usage data, a list of data sets defined by at least one category, an archiver for archiving the usage data within a predetermined time interval, and a client for an user interface for selecting and displaying the usage data.

### DESCRIPTION OF THE DRAWINGS

FIG. 1 is an architectural diagram of an implementation using the present invention;

FIG. 2 is a flow chart illustrating the preferred functionality of a method of the present invention;

FIG. 3 is an exemplary page displayed on the client using the data archived within a predetermined time interval; and,

FIG. 4 is another exemplary page displayed on the client using the data archived within a predetermined time interval.

### GLOSSARY OF TERMS AND ACRONYMS

The following terms and acronyms are used throughout the detailed description:

Archiver. A computer for archiving data collected by the data collector of an Internet Usage Manager system within a predetermined time interval.

Archive. A single file containing one or more separate files plus information into a format, such as XML or Binary, that allows them to be extracted by a suitable program.

Binary data. A file format for digital data encoded as a sequence of bits but not consisting of a sequence of printable characters (text). The term is often used for executable machine code.

Common Object Request Broker Architecture (“CORBA”). An Object Management Group (“OMG”) specification which provides the standard interface definition between OMG-compliant objects.

Data Collector. A module in the Internet Manger Usage system that continuously collect usage data of the server.

Extensible Markup Language (“XML”). An initiative from the W3C defining an “extremely simple” dialect of SGML suitable for use on the World-Wide Web.

Hyperlink. A navigational link from one document to another, from one portion (or component) of a document to another, or to a Web resource, such as a Java applet. Typically, a hyperlink is displayed as a highlighted word or phrase that can be selected by clicking on it using a mouse to jump to the associated document or document portion or to retrieve a particular resource.

HTML (HyperText Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

Hyper Text Transport Protocol (“HTTP”). The standard World Wide Web client-server protocol used for the exchange of information (such as HTML documents, and client requests for such documents) between a browser and a Web server. HTTP includes a number of different types of requests, which can be sent from the client to the server to request different types of server actions. For example, a “GET” request, which has the format GET <URL>, causes the server to return the document or file located at the specified URL.

Internet. A collection of interconnected or disconnected networks (public and/or private) that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols).

Internet Usage Manager (“IUM”). A computer implemented system for managing usage data of the server.

Object Management Group (“OMG”). A consortium aimed at setting standards in object-oriented programming.

Object-Oriented Programming. The use of a class of programming languages and techniques based on the concept of an “object” which is a data structure (abstract data type) encapsulated with a set of routines that operates on the data. Operations on the data can only be performed via the routine sets. These routine sets are common to all objects that are instances of a particular “class”. As a result, the interface to objects is well defined, and allows the code implementing the routine sets to be changed so long as the interface remains the same.

Standard Generalized Markup Language (“SGML”). A generic markup language for representing documents. SGML is an International Standard that describes the relationship between a document's content and its structure. SGML allows document-based information to be shared and re-used across applications and computer platforms in an open, vendor-neutral format.

URL (Uniform Resource Locator). A unique address which fully specifies the location of a file or other resource on the Internet or a network. The general format of a URL is protocol://machine address:port/path/filename.

Usage Data. Data collected by the IUM relating, among other things, to information on users, sessions and usage.

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

### DETAILED DESCRIPTION

Broadly stated, the present invention is directed to an improved method and system for archiving data. The method and system provide an archiver for archiving data collected by a data collector of an IUM within a predetermined time interval. Because the archiver can be set up separately to collect data within a predetermined time interval, usage data can be displayed to users according to years, months, weeks, days, hours, minutes and seconds. Usage information provided in such a context can greatly assist managers in understanding the behavior and usage of users.

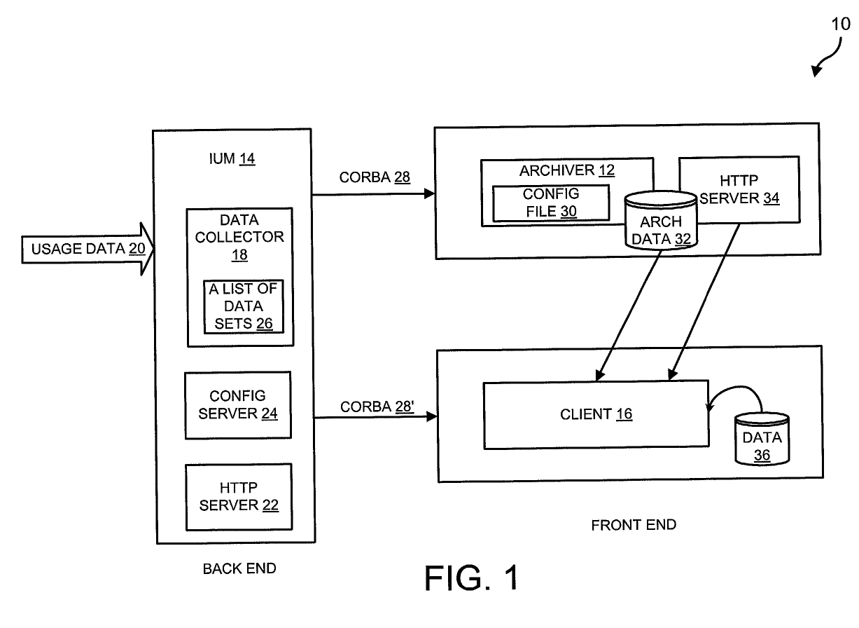

An architectural diagram of an implementation using the present invention with an IUM is shown in FIG. 1, and indicated generally at 10. An archiver 12 is connected between an IUM 14 and a client 16. The IUM 14 is a computer for managing server statistical usage data, and includes a data collector 18 for collecting usage data 20 of users using a HTTP server 22 with specific server configurations 24. It should be noted that the preferred implementation of the present invention is for use with Internet servers (e.g. HTTP servers). However, other servers such as intranet or network servers can be used. These other implementations with the use of other types of servers are within the scope of the present invention. A list of a plurality of data sets 26 defined by at least one category is also included with the IUM. Data collected by the data collector is grouped according to each data set in the lists.

The IUM 14 is preferably linked to the archiver 12 and the client 16 via a CORBA connection 28, 28′. Using the settings defined in the configuration file 30, the archiver 12 automatically archives data from the data collector within a predetermined time interval. The archived data 32 is then saved locally. Because the archiver 12 also services the client 16, a HTTP server 34 is preferably used for storing the archived data 32 and servicing the client.

The client 16, on the other hand, is a user interface for displaying the usage data collected by the archiver 12 or the data collector 18 of the IUM 14. If a user desires usage data within a predetermined time interval, the client gathers the needed data from the archive. However, the client 16 can also access the data collector 18. In fact, the client can access data 36 saved locally on the client.

Although it is shown that the archiver 12, the IUM 14 and the client 16 are located on different computers, they can be combined together in any number of computers depending on the preferred implementation. In fact, as known by those of ordinary skilled, the network topology of the present invention can be implemented in various ways, and these other implementations are within the scope of the present invention.

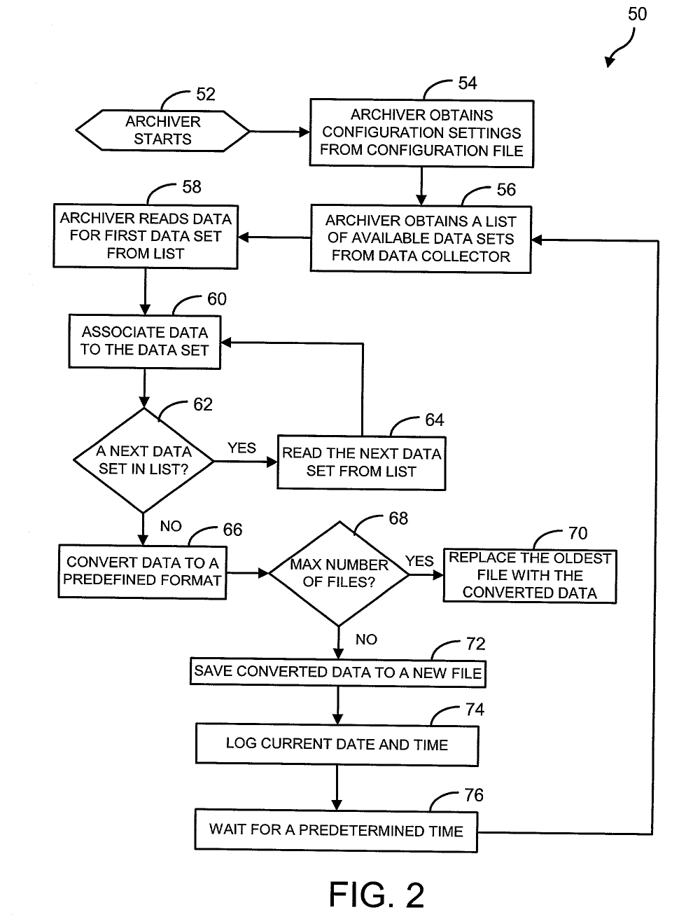

Turning to an important aspect of the preferred embodiment of the present invention, a flow chart of the preferred functionality of a configuration method is shown in FIG. 2, and indicated generally at 50. At the start of the archiver (Block 52), it first obtains configuration settings from the configuration file (Block 54), which preferably includes a URL of the data collector, a maximum number of files allowed and a predetermined time interval for collecting the data. Other information and settings relating to the archiver can also be included in the configuration file. Next, the archiver obtains a list of available data sets from the data collector (Block 56).

The archiver will archive data associated with each data set in the list. More specifically, the archiver reads data for the first data set from the list (block 58). The data will be associated with this first data set (block 60). It is next determined whether there is a next data set in the list (block 62). If there is, the archiver will continue to read the next data set from the list (block 64) and an association of the data will similarly be made with this next data set (Block 60). The archiver continues reading the data for each data set from the list (block 64) until a next data set is no longer available in the list (block 62). Once all the data has been read for every data set in the list (block 62), the read data is converted to a predefined archive format (block 66). The preferred archive format is preferably either binary or XML. However, any archive format can be used, and they are within the scope of the present invention.

Before the converted data is saved locally on the archiver, it is first determined whether there is already the maximum number of files allowed (Block 68). A maximum number of files allowed is preferably provided for in the configuration file to avoid having endless megabytes of files that unnecessarily take up memory of the archiver. Although it is not essential to the method, it is preferred that some type of maintenance for the archiver is included with the present method. If the maximum number of files allowed are already in the system (block 68), the converted data will be saved by replacing it in the oldest file allowed in the system (block 70). On the other hand, if the maximum number of files allowed are not already in the system (block 68), the converted data will then be saved onto a new file (block 72). Once the converted data has been saved, the archiver will log the date and time to indicate when the data was collected and archived from the data collector of the IUM (block 74). The archiever will then wait for a predetermined time from the last logged date and time (block 76) to restart the process from the step of obtaining a list of available data sets from the data collector (block 56).

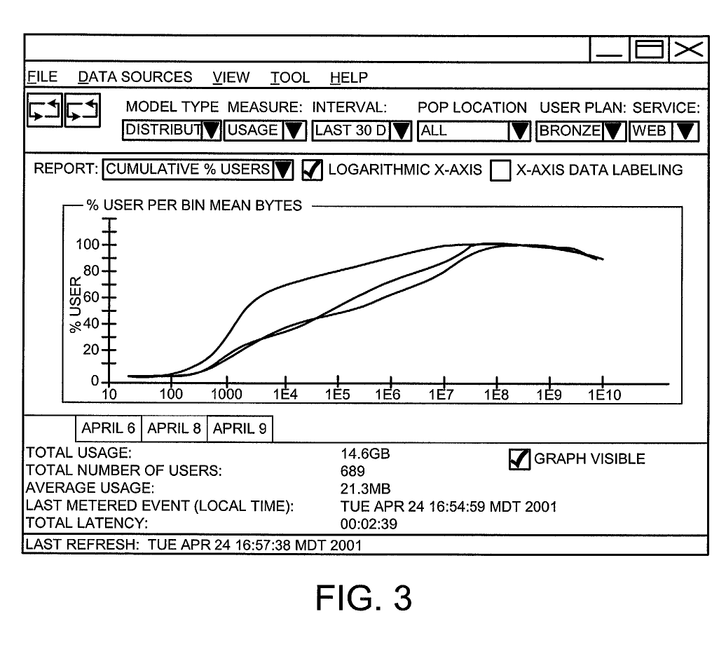

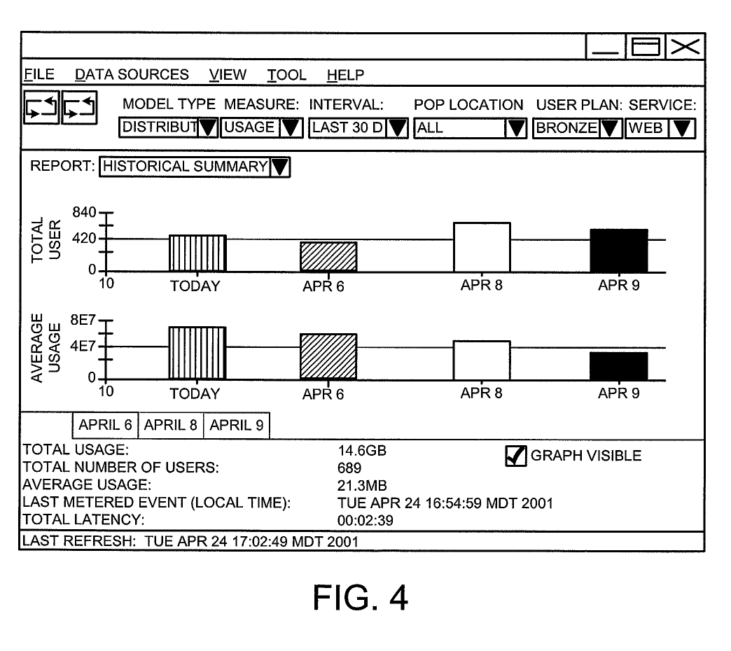

Exemplary pages displayed on the client using the data archived within a predetermined time interval by the archiver is shown in FIGS. 3 and 4. Because the archiver collects data according to a predetermined time interval, such as once a day, various histograms, graphs and charts can be viewed within a time interval set by users. Near the top of the screen, users can choose specific parameters relating to categories of model type, measure, time interval, geographical location, user plan or user service. In this example, the data set is defined as “distribution” for model type, “usage” for measure, “last 30 days” for time interval, “all” for geographical location, “bronze” for user plan and “web” for user service.

A single data set with these specific parameters is defined in the list. For example, if the category time interval is changed to last week with the other categories remaining the same, another data set is defined for these parameters. Thus, in the list of the IUM, the preferred embodiment has thousands of data sets. However, as shown, both examples in FIGS. 3 and 4 define the same data set, and the only difference is the type of report the user selected. More specifically, a cumulative % users for FIG. 3 and a historical summary for FIG. 4.

Because the archiver automatically archives the data within a predetermined time interval, the client is able to view data according to various time interval, which is not available through the data collector of the IUM. As a result, managers can view usage data that are more relevant to marketing. The archiver provides an additional dimension to IUM systems for providing an improved and valuable marketing tool.

From the foregoing description, it should be understood that an improved method and system for archiving data for use with an IUM has been shown and described, which has many desirable attributes and advantages. The method and system provide users with data according to a predetermined time interval on the IUM. As a result, a time interval category is added to the IUM systems, which provides important data information. Thus, the archiver provides an additional dimension for data archiving in IUM systems.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for archiving data using an archiver connected to a data collector having a list of available data sets of an Internet Usage Manager within a predetermined time interval, comprising the steps of:
obtaining a list of available data sets from the data collector;
reading data for a data set from the list;
associating read data to the data set;
converting all the read data to a predefined archive format once data from each available data set in the list is read;
saving the converted data to a file; and,
waiting for a predetermined time to repeat the foregoing steps.

2. The method according to claim 1 wherein said archiver is configured for use with an Internet Usage Manager system.

3. The method according to claim 1 wherein said data set includes any one from the category of model type, measure, time interval, geographical location, user plan or user service.

4. The method according to claim 1 wherein the converted data is in Binary Language or Extensible Markup Language.

5. The method according to claim 1 wherein prior to the step of obtaining a list of available data sets further comprises the step of obtaining configuration settings from a configuration file for the archiver.

6. The method according to claim 5 wherein said configuration file comprises an uniform resource locator of the data collector, a maximum number of files allowed, and a predetermined time interval for collecting the data.

7. The method according to claim 1 wherein said step of reading data for a data set from the list further comprises the step of:
reading a first data set from the list;
associating read data to the first data set;
determining whether there is a next data set available in the list;
reading the next data set from the list when there is a next data set available in the list; and,
converting the read data once there is no next data set available in the list.

8. The method according to claim 1 wherein said step of saving the converting data to a file further comprises the steps of:
determining whether there is already a maximum number of files allowed;
replacing the oldest file with the converted data if there is already a maximum number of files allowed;
saving the converted data to a new file if there is not a maximum number of files allowed.

9. The method according to claim 1 wherein prior to said step of waiting for a predetermined time further comprising the step of logging the current date and time.

10. A computer program product comprising a computer usable medium having computer readable program codes embodied in the medium that when executed causes a computer to:
obtain a list of available data sets from the data collector;
read data for a data set from the list;
associate read data to the data set;
convert all the read data to a predefined archive format once data for each available data set in the list is read;
save the converting data to a file; and,
wait for a predetermined time to repeat the process.

11. An archiver for archiving data within a predetermined time interval connected to an Internet Usage Manager system having a data collector for collecting available data for a list of data sets to:
obtain a list of available data sets from the data collector;
read data for a data set from the list;
associate read data to the data set;
convert all the read data to a predefined archive format once data for each available data set in the list is read;
save the converting data to a file; and,
wait for a predetermined time to repeat the process.

12. A system for archiving data using an archiver connected to a data collector having a list of available data sets of an Internet Usage Manager within a predetermined time interval, comprising:
an Internet Usage Manager system for managing usage data of a server;
a data collector of said Internet Usage Manager system for collecting the usage data;
a list of data sets defined by at least one category;
an archiver for archiving the usage data within a predetermined time interval;
a client for an user interface for selecting and displaying the usage data.
